(19) United States
(12) Patent Application Publication
(10) Pub. No.: US 2019/0224059 A1
(43) Pub. Date: Jul. 25, 2019

(54) DIAGNOSTIC AND REHABILITATION SEAT PAD AND DIAGNOSTIC AND REHABILITATION DEVICE

(71) Applicant: Martin Trencanský, Modrice (CZ)

(72) Inventor: Martin Trencanský, Modrice (CZ)

(21) Appl. No.: 16/330,327

(22) PCT Filed: Sep. 12, 2017
(86) PCT No.: PCT/IB2017/055489

§ 371 Date: Mar. 4, 2019

(30) Foreign Application Priority Data
Sep. 12, 2016 (CZ) 2016-32798 U

(51) Int. Cl. A61G 5/10; A61G 7/057; A47C 27/08

(52) U.S. Cl. CPC A61G 5/1091; A61G 7/05769; A61G 2200/34; A61G 2203/42; A47C 27/081

(57) ABSTRACT

A diagnostic and rehabilitation seat pad containing an inflatable element (1), at least one gyroscopic sensor (20) for sensing inclination of at least part of the seat pad during use, an energy source (21) for the gyroscopic sensor (20) and a communication unit (31) for data transmission by the gyroscopic sensor (20). A diagnostic and rehabilitation device containing a diagnostic and rehabilitation seat pad (30), an evaluating and determining unit (32) for data evaluation sensed by the gyroscopic sensor (20) of the diagnostic and rehabilitation seat pad (30) and for determination of pathological manifestations of the user wherein the evaluating and determining unit (32) is equipped with a database (33) of pathologies during sitting, wherein the evaluating and determining unit (32) for data evaluation and determination of pathologies is connected to the communication unit (31) of the diagnostic and rehabilitation sat pad (30) for data transmission, the evaluating and determining unit (32) for data evaluation and determination of pathologies is connected to an output unit (34).

### TECHNICAL FIELD

This invention concerns diagnostic and rehabilitation seat pad and diagnostic and rehabilitation device.

### BACKGROUND ART

Sitting on a chair causes static overload of a spine, which leads to degeneration of intervertebral discs and atrophy of stabilizing muscles, mainly in a spinal and abdomen area. In state of the art, seat pads are known, but they do not solve dynamic-directional movements. These seat pads are trying to be balance in that way that they create an unstable area by their inflating. The seat pad forces the user to balance this instability during sitting and thus certain muscles are engaged.

However, these seat pads do not solve problems occurring as a result of long-term sitting nor consider health condition of the users, and the like. These already existing seat pads also do not allow to evaluate user's style of sitting and pathologic manifestations during the user's sitting and eventually, based on such evaluations, they do not provide a possibility of specific rehabilitation exercise. Concurrently, there is a demand for further increasing of effect of seat pads on body posture of the user in terms of the muscle types involved in balancing of seat pad's instability and directing of created muscular load.

### NATURE OF INVENTION

The aim of this invention is to create such diagnostic and rehabilitation seat pad that would not only support creating muscle activity due to its instability and targeted positioning of the body during sitting on the seat pad, but would also allow diagnostics of the user's sitting style and pathologic manifestations of the user during sitting and based on such diagnostics would determine a targeted rehabilitation exercises.

The above-mentioned task is solved by diagnostic and rehabilitation seat pad for dynamic-directional sitting, which contains an inflatable element and at least one gyroscopic sensor for sensing movements of an upper side of the diagnostic and rehabilitation seat pad.

A plan view of the inflatable element preferably contain a back side, concave lateral sides and a concave front side.

In a particular preferable embodiment, the inflatable element is divided into at least two chambers which are interconnected through at least one release opening.

Plan view of the inflatable element has the maximum width of 38 to 42 cm in the front part, the maximum width of 36 to 40 cm in the back part and the maximum width of 33 to 37 cm in the central part, wherein the maximum width in the front part is greater than the maximum width in the back part, which is greater than the maximum width in the central part of the seat pad's plan view.

In a specific preferable embodiment, the inflatable element comprises a pair of chambers which are arranged in the plan view one above the other, wherein the perimeter of plane shape of both chambers is the same and they are interconnected through at least one release opening which is arranged on the central line passing between the concave lateral sides.

In other specific preferable embodiment, the inflatable element comprises a pair of chambers which are arranged in plan view one above the other, wherein the perimeter of plane shape of both chambers is the same, wherein the inflatable element comprises three release openings to interconnect the chambers. One of them is arranged near to the front side of their plan view but with a distance therefrom, on the central line passing between the concave lateral sides, while the other two openings are arranged symmetrically with regard to the central line, near the back side but with a distance therefrom, wherein the seat pad comprises a gyroscopic sensor arranged in the front part on the central line, a gyroscopic sensor arranged in the back part on the central line and a pair of gyroscopic sensors arranged in the central part with a distance from the central line and symmetrically with one another with regard to it.

In some cases, it is preferable when the inflatable element comprises a central reduced area passing along the central line and at least two gyroscopic sensors arranged outside the central reduced area but symmetrically with regard to the central line.

The inflatable element preferably comprises the central reduced area passing along the central line from an outer edge of the back side to a transitional area between the central part and the front part, wherein the seat pad contains the gyroscopic sensor arranged on the central line between the central reduced area and an outer edge of the front part and also a pair of gyroscopic sensors arranged in the back part, symmetrically with one another with regard to the central line.

The inflatable element may also comprise the central reduced area passing along the central line, which is terminated with a distance from the outer edge of the back part and also from the outer edge of the front part, wherein the seat pad contains the gyroscopic sensor arranged in the back part between the central reduced area and one of the lateral sides, and the gyroscopic sensor arranged in the front part between the central reduced area and the other lateral side.

Preferably, the seat pad comprises also a cover (which is preferably made of textile on upper side and of rubber or PVC foil on bottom side and is provided with peripheral hem along the sides).

The data obtained during use can be processed for different purposes. In particular it is preferable to analyse obtained data in terms of engagement of the user's particular muscles during short-term and long-term sitting, to evaluate potential pathologic manifestations, and/or, optionally, to determine the diagnosis. Appropriateness of specific rehabilitation exercises can be also concluded from the data. It is preferable when evaluation is performed by computer program. Furthermore, it is possible to create a computer program for subsequent exercising, for example in a form of game controlled by gyroscopic sensors in the seat pad. Alternatively, it is possible to evaluate correctness of sitting on the basis of currently obtained data from gyroscopic sensors and in case of an incorrect style to produce a warning audio or video signal. Alternatively or in addition, recorded data enable to determine presence and working participation of the employee in working place.

Gyroscopic sensors can be supplemented with pressure sensors to obtain more precise sensed values or to provide more precise possibilities of evaluations.

Disadvantages of the state of the art are considerably eliminated by the diagnostic and rehabilitation device that comprises the diagnostic and rehabilitation seat pad according to this invention. The device also contains evaluating and determining unit for evaluation of data sensed by the gyroscopic sensor of the diagnostic and rehabilitation seat pad and for determination of pathological manifestations of the user. The evaluating and determining unit is equipped with a database of pathologies during sitting. The evaluating and determining unit for data evaluation and determination of pathologies is connected to a communication unit of the diagnostic and rehabilitation seat pad for data transmission. The evaluating and determining unit for data evaluation and determination of pathologies is connected to an output unit.

The gyroscopic sensor of the diagnostic and rehabilitation seat pad, optionally equipped with the pressure sensors, senses movement of the outer side of the diagnostic and rehabilitation seat pad and optionally senses also the pressure applied on the seat pad by the person using the seat pad. These measured data are transmitted by the communication unit of the diagnostic and rehabilitation seat pad to the evaluating and determining unit. The evaluating and determining unit evaluates data received from the communication unit and using the database of pathologies determines which pathologies are present during sitting. The output unit provides data about determined present pathologies to the user.

Preferably, the diagnostic and rehabilitation device further contains an assignment unit for assigning rehabilitation exercises in order to eliminate pathologic manifestations of the patient. The assigning unit is equipped with a database of rehabilitation exercises, wherein the database also contains information about that which rehabilitation exercises are appropriate for eliminating particular pathological manifestations. The assignment unit is connected to the evaluating and determining unit for data evaluation and determination of pathologies and optionally to the output unit. The output unit provides to the user not only data about determined present pathologies but also about rehabilitation exercises appropriate for identified present pathological manifestations.

Preferably the diagnostic and rehabilitation device further contains a signalling unit for signalization of the presence of pathology. The signalling unit is connected to the evaluating and determining unit.

The output device can be a monitor and/or a printer. The signalling device can be a speaker for sound signalling and/or a monitor or a light source for image signalization.

### DESCRIPTION OF FIGURES

The invention is further disclosed in more detail by means of examples and figures, wherein

FIG. 1 depicts the plan view of the inflatable element of the seat pad disclosed in example 1,

FIG. 2 depicts the plan view of the inflatable element of the seat pad disclosed in example 2,

FIG. 3 depicts the plan view of the inflatable element of the seat pad disclosed in example 3 and FIG. 4 depicts the plan view of the inflatable element of the seat pad disclosed in example 4. FIG. 5 schematically depicts the diagnostic and rehabilitation device.

### EXAMPLES OF EMBODIMENTS

The seat pad comprises the cover and the inflatable element arranged inside it. Additionally, the seat pad can contain the layer of thermal insulating foam arranged between the cover and the inflatable element having the same plane shape as the seat pad and the cover only with accordingly smaller proportions in order the cover could be put on it.

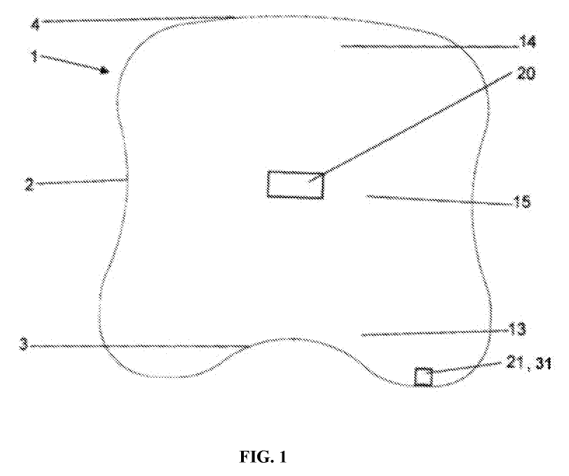

FIG. 1 depicts plan view of the embodiment of the inflating element 1 of the seat pad for dynamic-directional sitting according to example 1 of this invention. The plane shape is substantially rectangular (or slightly trapezoidal) with rounded corners but the lateral sides 2 are concave with a radius of curvature of 200 mm and the front side 3 is also concave with a radius of curvature of 133 mm. Due to the concave lateral sides 2, the inflatable element 1 is narrowed in the plane shape in the middle part 15, or it measures in the back part 14 at the widest point 380 mm, in the front part 13 at the widest point 400 mm and in the central part 15 at the narrowest point 350 mm. This shape is advantageous from the anatomical point of view because a pelvic bone as such is supported during sitting on the seat pad, while hips or articulations of femurs are disposed at least partially outside the seat pad in areas closely adjacent to their concave lateral sides 2. This contributes to unintentional straightening of the seat pad user during sitting and to creating of swinging movements to the left and right and forward and backward.

The back side 4 of the plane shape of the inflatable element can be straight or slightly convex. The cover of the seat pad according to this invention has always the above mentioned shape. In terms of proportions, the cover is accordingly larger so it is possible to put the inflatable element 1 inside it and sew it up, optionally also with identically created (in terms of plane shape) thermal insulating foam, and at the same time the cover is adjacent to the content (the inflatable element and optionally also the thermal insulating foam) which is put inside it.

The seat pad also contains a configuration that comprises the gyroscopic sensor 20 arranged next to an outer surface of the seat pad in the central part, the communication unit 31, for example Bluetooth, and also the energy source 21 for the gyroscopic sensor 20, being a battery, the position of which is depicted in the front side of the seat pad but its placement is practically arbitrary. The gyroscopic sensor 20 can be attached to the outer surface of the inflatable element 1 on its internal or external side or to its optional layer of thermal insulating foam, or alternatively also to the cover on its internal side. The gyroscopic sensor 20 is preferably triaxial and serves for sensing the inclination of the upper surface of the seat pad. That allows for automatic monitoring of the user's sitting style and evaluation of types of muscles engaged during short-term and long-term sitting. For transmission of measured data is used the communication unit 31, which is preferably adjusted for wireless data transmission. Using the communication unit 31, the sensed data can be transferred into computer, tablet or mobile phone for evaluation.

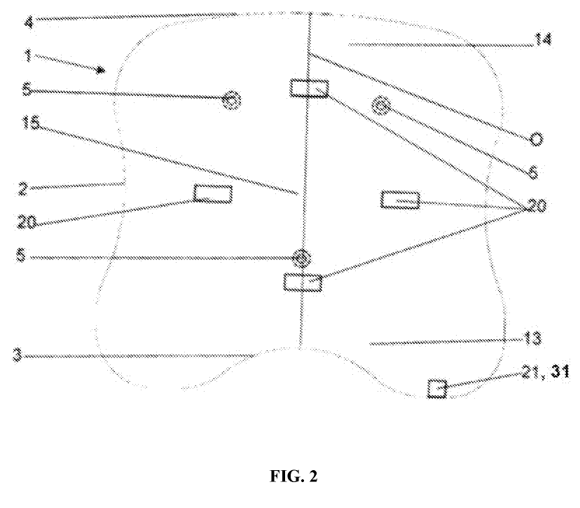

The inflatable element 1 in FIG. 2 differs from the inflatable element in FIG. 1 both by number and distribution of the gyroscopic sensors 20 and by the fact that it is double-chambered, wherein both chambers have the above mentioned plane shape and are positioned one above the other and interconnected through the release openings 5 (which from the top view on the inflatable element 1 are not visible but in drawings are indicated with a dashed line). One release opening 5 is arranged in the area of the central line O between the concave lateral sides 2 and on the boundary between the front part 13 and the central part 15 or approximately on the border of the first third from the front side 3. The other two release openings 5 are arranged in the back part 14 symmetrically with regard to the central line O passing between the concave lateral sides 2. Perimeter of the release openings is 7 to 12 mm, preferably 10 mm.

In this embodiment, four gyroscopic sensors 20 are arranged on the outer surface of the inflatable element 1, the gyroscopic sensors 20 are connected to the shared energy source 21 and to the shared communication unit 31 for transfer of sensed data to the electronic device. Two gyroscopic sensors 20 are arranged on the central line O, one of them in the front part 13 and the other in the back part 14, and two gyroscopic sensors 20 are arranged in the central part with a distance from the central line O. The gyroscopic sensors 20 thus allow more complex and more precise measurement of changes in inclination of individual parts of the seat pad, and thus also evaluation of the user's muscle activity.

Maximum height (in a direction perpendicular to the plane view depicted in the figure) of the inflatable element 1 in FIG. 1 after inflating is 50 to 180 mm.

The seat pad with the inflatable element of the embodiment according to FIGS. 1 and 2 is particularly appropriate for creating muscle activity and directing such activity into submerged stabilizing muscles of back, abdomen and thighs and gluteal muscles.

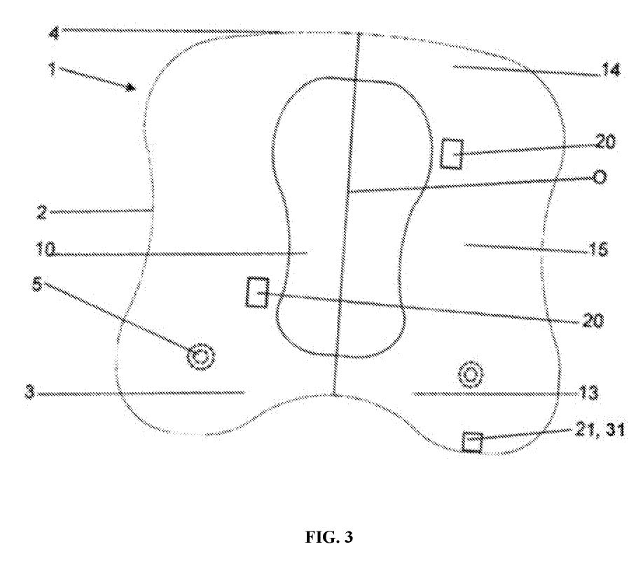

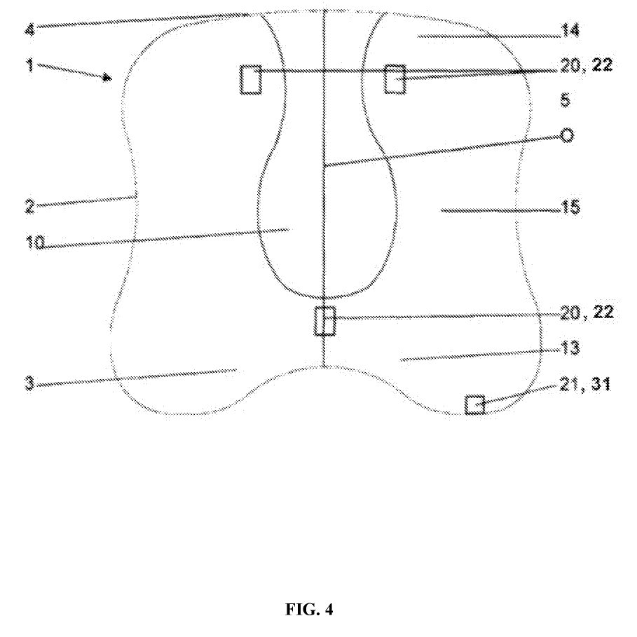

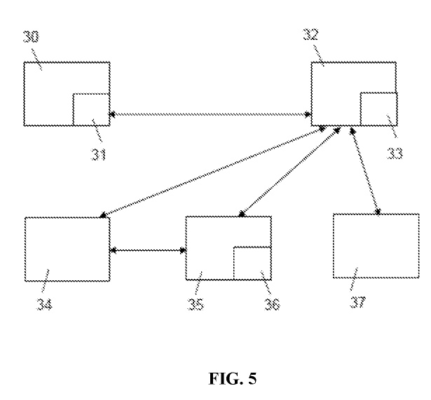

Embodiment of the inflatable element 1 depicted in FIG. 3 differs from embodiment in FIG. 1 or 2 mainly by that it comprises the central reduced area 10 arranged from both sides along the central line O, but does not reach to the outer edge of the front part 13 and the back part 14. The central reduced area 10 can be preferably 100 mm wide in the back part 14 and 80 mm wide in the front part 13.

The gyroscopic sensors 20 are arranged so that one is in the back part 14 on one side of the central reduced area 10 and the other is in the front part 13 on the other side of the central reduced area 10.

Furthermore, in area on the central line O between the outer edge of the back part 14 and the central reduced area 10 and/or between the outer edge of the front part 13 and the reduced area 10 a release opening (not depicted) can be arranged for air releasing from the right part to the left part of the inflatable element 1 and in the opposite direction.

Alternatively, in another embodiment the inflatable element 1 contains a pair of chambers arranged one above the other that have identical plan view and are interconnected through at least one release opening (not depicted).

The central area 10 is reduced in side view, which is accomplished either in such way that the central area 10 is not inflatable at all and only structurally inflatable side areas, or the central area 10 is inflatable but after inflating has lower height than the side areas.

In the embodiment of FIG. 4, the inflatable element 1 comprises also the central reduced area 10, but this one extends to its outer edge in the back part 14.

There are three gyroscopic sensors 20, one of them is positioned on the central line O between the central reduced area 10 and the edge of the front part 13 and two are in the back part 14, each of them in one area adjacent to the central reduced area 10. Each gyroscopic sensor 20 contains pressure sensors 22 to obtain more precise sensed values or to provide more precise possibilities of evaluations.

In all embodiments, optional release openings 5 are preferably equipped with enforcement on their edges. It is also obvious that even though they are depicted as circular, it is possible to make them another shape, for example oval, square, rectangular etc.

In FIG. 5 is schematically depicted the diagnostic and rehabilitation device. The diagnostic and rehabilitation device comprises diagnostic and rehabilitation seat pad 30 according to examples 1 to 4. The diagnostic and rehabilitation device also comprises evaluating and determining unit 32 for evaluation of data sensed by the gyroscopic sensor 20 of diagnostic and rehabilitation seat pad 30 and for determination of pathological manifestations of the user.

The evaluating and determining unit 32 is equipped with the database 33 of pathologies of the user during sitting. The evaluating and determining unit 32 for data evaluation and determination of pathologies is connected to the communication unit 31 of the diagnostic and rehabilitation seat pad 30 for data transmission. The evaluation and determination unit 32 for data evaluation and determination of pathologies is connected to the output unit 34, which is the monitor with speakers and the printer.

The diagnostic and rehabilitation device also comprises the assignment unit 35 for assigning rehabilitation exercises to eliminate pathological manifestations of the patient. The assignment unit 35 is equipped with the database of rehabilitation exercises and the database contains also information about that which rehabilitation exercises are appropriate for elimination of specific pathologies. The assignment unit 35 is connected to the evaluating and determining unit 32 for data evaluation and determination of pathologies and optionally to the output unit 34. The output unit 34 provides to the user not only data about determined present pathologies but also about rehabilitation exercises appropriate for the identified present pathological manifestations. The monitor with the speakers serves as the signalling unit 37 for signalization of the presence of pathology. The signalling unit 37 is connected to the evaluating and determining unit 32 for data evaluation and determination of pathologies. In the case of presence of pathological manifestation, the monitor visually and the speaker acoustically alert the user to presence of pathology.

Even though a number of embodiments is described, it is obvious that a skilled person in the art can easily find further possible alternatives to these embodiments. Therefore extent of this patent is not limited to these embodiments disclosed in examples but is rather given by definition of the attached patent claims.

1. A diagnostic and rehabilitation seat pad, wherein the diagnostic and rehabilitation seat pad contains an inflatable element, at least two gyroscopic sensors for sensing inclination of at least part of the surface of the seat pad during use, an energy source for the gyroscopic sensors and a communications unit for data transmission sensed by the gyroscopic sensors.

2. The diagnostic and rehabilitation seat pad according to claim 1, wherein at least two gyroscopic sensors are arranged with a distance from a central line, wherein at least one of the gyroscopic sensors is between the central line and a first lateral side and at least one of the gyroscopic sensors is between the central line and a second lateral side.

3. The diagnostic and rehabilitation seat pad according to claim 1, wherein the inflatable element comprises a central reduced area passing along a central line, wherein at least two gyroscopic sensors are arranged outside the central reduced area.

4. The diagnostic and rehabilitation seat pad according to claim 2, wherein the two gyroscopic sensors arranged with a distance from the central line are arranged symmetrically with one another with regard to the central line.

5. The diagnostic and rehabilitation seat pad according to claim 1, wherein the diagnostic and rehabilitation seat pad further contains at least one gyroscopic sensor arranged on a central line.

6. The diagnostic and rehabilitation seat pad according to claim 1, wherein the gyroscopic sensors contain pressure sensors.

7. The diagnostic and rehabilitation seat pad according to claim 1, wherein a plan view of the inflatable element contains a back side, concave lateral sides and a concave front side.

8. The diagnostic and rehabilitation seat pad according to claim 7, wherein the concave front side has a radius of curvature of 100 to 150 mm and/or the concave lateral sides have a radius of curvature of 150 to 250 mm.

9. The diagnostic and rehabilitation seat pad according to claim 1, wherein the maximum width of a front part is greater than the maximum width of a back part, which is greater than the maximum width of a central part of a plan view of the seat pad.

10. The diagnostic and rehabilitation seat pad according to claim 9, wherein the plan view of the inflatable element has a maximum width of 38 to 42 cm in the front part, a maximum width of 36 to 40 cm in the back part, and a maximum width of 33 to 37 cm in the central part.

11. The diagnostic and rehabilitation seat pad according to claim 1, wherein the inflatable element is divided into at least two chambers which are interconnected through at least one release opening.

12. The seat pad according to claim 7, wherein the inflatable element comprises a pair of chambers which are arranged in the plan view one above the other, wherein the perimeter of a plan shape of both chambers is identical and the chambers are interconnected through one release opening which is arranged on a central line passing between the concave lateral sides.

13. The seat pad according to claim 7, wherein the inflatable element comprises a pair of chambers which are arranged in the plan view one above the other, wherein the perimeter of a plan shape of both chambers is the same, wherein the inflatable element comprises three release openings to interconnect the chambers, one of which is arranged near the front side of their plan view but with a distance therefrom, on a central line passing between the concave lateral sides, while the other two release openings are arranged symmetrically with regard to the central line near the back side but with a distance therefrom, wherein the seat pad contains a gyroscopic sensor arranged in a front part on the central line, a gyroscopic sensor arranged in a back part on the central line and a pair of gyroscopic sensors arranged in a central part with a distance from the central line and symmetrically with one another with regard to the central line.

14. The seat pad according to claim 1, wherein the inflatable element comprises a central reduced area passing along a central line and at least two gyroscopic sensors arranged outside the central reduced area and symmetrically with regard to the central line.

15. The seat pad according to claim 1, wherein the inflatable element comprises a central reduced area passing along a central line from the outer edge of a back part to a transitional area between a central part and a front part, wherein the seat pad contains a gyroscopic sensor arranged on the central line between the central reduced area and the outer edge of the front part and also comprises a pair of gyroscopic sensors arranged in the back part symmetrically with one another with regard to the central line.

16. The pad according to claim 1, the inflatable element comprises a central reduced area passing along a central line which is terminated with a distance from the outer edge of a back part and also from the outer edge of a front part, wherein the seat pad contains a gyroscopic sensor arranged in the back part between the central reduced area and one of its lateral sides and a gyroscopic sensor arranged in the front part between the central reduced area and a second lateral side.

17. The seat pad according to claim 1, wherein the diagnostic and rehabilitation seat pad comprises a cover inside which the inflatable element is placed.

18. A diagnostic and rehabilitation device comprising the diagnostic and rehabilitation seat pad according to claim 1, an evaluating and determining unit for evaluation of data sensed by the gyroscopic sensors of the diagnostic and rehabilitation seat pad and for determination of pathological manifestations of a user, wherein the evaluating and determining unit is equipped with a database of pathologies during sitting, wherein the evaluating and determining unit for data evaluation and determination of pathologies is connected to a communication unit of the diagnostic and rehabilitation seat pad for data transmission, and the evaluating and determining unit for data evaluation and determination of pathologies is connected to an output unit.

19. The diagnostic and rehabilitation device according to claim 18, wherein the diagnostic and rehabilitation device further contains an assignment unit for assignment of rehabilitation exercises in order to eliminate a patient's pathological manifestations, wherein the assignment unit is equipped with a database of rehabilitation exercises with determination of suitability for elimination of individual pathologies and is connected to the evaluating and determining unit for data evaluation and determination of pathologies and optionally to the output unit.

20. The diagnostic and rehabilitation device according to claim 18, wherein the diagnostic and rehabilitation device further contains a signalling unit for signalization of a presence of pathology connected to the evaluating and determining unit for data evaluation and determination of pathologies.
